(19) United States
(12) Patent Application Publication
(10) Pub. No.: US 2009/0195786 A1
(43) Pub. Date: Aug. 6, 2009

(54) DEVICE FOR INSPECTING SEMI-CONDUCTOR WAFERS

(76) Inventor: Philippe Gastaldo, Pontcharra (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 12/101,674

(22) Filed: Apr. 11, 2008

(30) Foreign Application Priority Data
Feb. 5, 2008 (FR) 0800597

(51) Int. Cl. G01B 9/02

(52) U.S. Cl. 356/477

(57) ABSTRACT

Device for inspecting semi-conductor wafers in motion, including a light source for at least one wafer supported by a transfer element, the said light source being configured to transmit two incident beams on to a surface of the wafer, the incident beams being inclined relative to the normal to the surface, the device also including a unit for detecting interference fringes in the beam reflected by the surface of the wafer.

### BACKGROUND OF THE INVENTION

1. Field of the Invention

The present invention relates to the field of machines for and methods of inspecting the quality of a semi-conductor wafer during or at the end of manufacture.

2. Description of the Relevant Art

Conventionally, inspection of semi-conductor wafers was carried out visually by an operator. The human eye is in fact capable of detecting defects of a relatively small size on semi-conductor wafers having, to the unpracticed eye, the appearance of a mirror. The higher the quality of manufacture, the more easily the human eye can pick up minor defects. However, the development of etching technologies of ever increasing intricacy means that the human eye has reached the limit of its detection capacity in particular for certain types of defect.

Furthermore, the task of visually inspecting semi-conductor wafers is slow and tricky and does not yield precise information of location and classification of the defects. In a clean room for the manufacture of semi-conductor wafers, it is desirable to reduce human presence. Visual inspection has also proved to be expensive.

### SUMMARY OF THE INVENTION

A device for inspecting semi-conductor wafers includes a light source for illuminating at least one wafer supported by a transfer element, the light source being configured to transmit two incident beams on to a surface of the wafer. The incident beams form between them a predetermined angle in order to form an interference zone and are inclined relative to the normal to the said surface. The device includes a unit for detecting the light diffused by the wafer surface in order to detect fringes of interference including the beam reflected by the surface of the wafer. The detection unit is configured to form electronic signals representing defects in the surface of the wafer.

A method of monitoring semi-conductor wafers supported by a transfer element may include illumination by two incident beams of at least one surface of the wafer, the incident beams being inclined relative to the normal to the surface, and detection by a detection block for detecting fringes of interference in the beam reflected by the wafer surface. Illumination and detection take place during displacement of the wafer by the said transfer element.

A system of transfer and inspection of semi-conductor wafers belonging to a manufacturing machine in a production line for semi-conductor wafers includes a transfer element for at least one wafer, a light source configured to transmit an incident beam on to a surface of the wafer, the incident beams being inclined relative to the normal to the said surface, and a detector for detecting fringes of interference in the beam reflected by the surface of the wafer.

### BRIEF DESCRIPTION OF THE DRAWINGS

The invention will become clear from a reading of the detailed description of plural embodiments given by way of non-limiting example and illustrated by the attached drawings, in which:

FIG. 1 depicts a schematic view of a semi-conductor wafer during inspection;

FIG. 2 depicts a flow-diagram of the steps in the method;

FIG. 3 depicts a schematic view of an inspection device;

FIG. 4 depicts a schematic view of an inspection device;

FIG. 5 depicts a schematic view of an inspection device; and

FIG. 6 depicts a plan view of an embodiment of semi-conductor wafers.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

In the prior art, FR 2 722 290 and JP 2004 212117 relate to laboratory apparatus in different technological fields.

FR 2 675 574 relates to an optical sensor for monitoring the state of a surface, in particular for aligning a large microelectronics mask with the layer which it is to cover. This type of sensor is intended to be disposed inside a machine for manufacturing a semi-conductor with a view to alignment. This type of sensor is unsuitable for detecting defects in the surface of a semi-conductor wafer.

In general, the fringes of interference have sometimes been used to measure the speed of fluids in motion, cf. FR 2 722 290 or of the speed of a body, cf. FR 2 757 953. In the field of measuring speed, the frequency shift between a reflected light diffused or diffracted by the moving body and the incident light beam is used. This shift is a function of the ratio between the relative speed of the body in motion and the speed of light. The reflected light and the incident light may enter a detector in different directions, fringes of interference appearing on the plane of the detector.

The gap or interval between the fringes of interference may be found according to the following equation from the wavelength l of the light beam and of the shift e: d=l/sine. By approximation, when e is much less than 1, one has d=l/e. The gap d can be detected by the detector. The wavelength l depends on the source of light used and may be known. The shift e can thus be calculated.

Furthermore, the relative speed v of the body may be known, involving a semi-conductor wafer being moved by or on a machine, e.g. by a robot arm. The shift e also depends on the relative speed v and the speed of light c according to the equation e=v/c. When the surface of the semi-conductor wafer during inspection is sufficiently smooth, the two shift variables ev and ed obtained on the one hand from the relative speed of displacement of the object, and on the other hand by the measurement of fringes of interference, are substantially equal.

On the other hand, when an irregularity is present on the semi-conductor wafer, the two values of shift ev and ed obtained for an identical point on the surface are different. A subtraction carried out for plural local zones of the surface may then be used to generate a map of the irregularities. In the case of a linear translational displacement, the speed v of displacement of the semi-conductor wafer is identical for all the points forming the surface being inspected, and the value of shift ev calculated from the speed of displacement of the semi-conductor wafer is constant for all the points. It is possible to generate a map of shift ed from the gap between the fringes of interference and then to carry out subtraction point by point by taking away the value ev. This can be carried out by a thresholding operation. In the same manner, in the case of rotation of the wafer about an axis passing through its centre, the speed is known at any point of the wafer and a map can then be obtained by the same means.

Furthermore, more thorough inspection can be carried out by using the direction a of relative speed. The direction a of relative speed is known from the configuration of the element which ensures transfer of the semi-conductor wafer and is referenced av. The direction a of relative speed can be found from the following equation from the number of fringes nx present in a predetermined interval of coordinates x of the detector and from the number of fringes ny present in a predetermined interval of coordinates y of the same width as x:

ad=arc tang(nx/ny)

By comparing the two variables ad and av it is possible to plot surface irregularities of the semi-conductor wafer by detecting the points where the values ad and av are different.

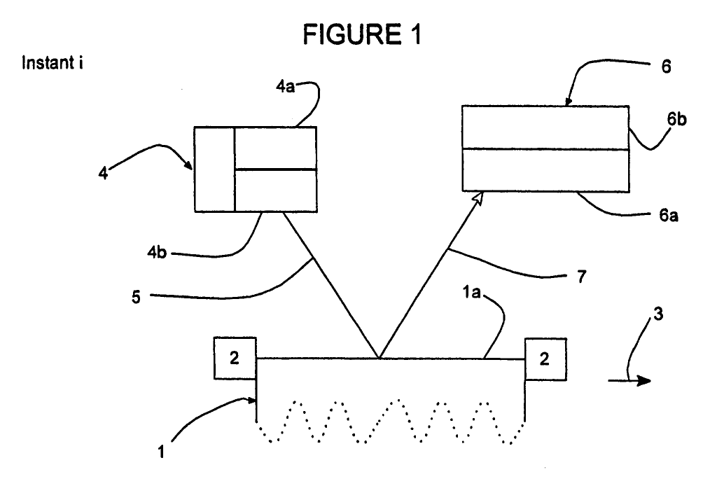

As can be seen from FIG. 1, a semi-conductor wafer 1 during or at the end of manufacture has an upper surface 1a to be inspected. The semi-conductor wafer 1 is supported and displaced by a transfer element 2, e.g. of the pincer type acting on the edge of the wafer 1 or by suction. The transfer element 2 displaces the wafer 1 in the direction of the arrow 3, e.g. in translation, or in rotation.

The device includes a light source 4 transmitting an incident light beam 5. The light source 4 may include a light, e.g. laser, generator 4a and a light conductor 4b, e.g. with a base of optical fibers. The light beam 5 has been shown on the drawings by a line for reasons of explanation. Nevertheless, it is obvious that the light beam 5 is provided in order to illuminate a portion of the upper surface of the wafer 1 or the whole upper surface of the wafer 1, or even more widely an area in which the semi-conductor wafer 1 is moving.

The device also includes a unit for detecting fringes of interference 6 receiving the beam 7 reflected by the upper surface of the semi-conductor wafer 1. The detection unit 6 includes one or more light intensity sensors 6a. The detection unit 6 also includes a processing block 6b. The processing block 6b receives data from the sensor 6a. The processing bock 6b may also include a filter, e.g. operating by thresholding.

The speed of displacement v of the semi-conductor wafer 1 by the transfer element 2 may be relatively high, e.g. of the order of 1 to 5 ms-1. The displacement of the semi-conductor wafer 1 makes it possible to eliminate supposed defects not moving at the speed of the semi-conductor wafer 1.

Inspection of the semi-conductor wafer 1 can be carried out in passing on a production line in a clean room. The monitoring and inspection device may be disposed upstream or downstream of a manufacturing machine, or incorporated therein, e.g. for depositing or etching a layer. The monitoring and inspection device may be disposed on an existing production line for semi-conductor wafers with minor modifications such as the use of an output of the transfer element 2 making it possible to supply to the monitoring and inspection device the speed v of displacement by the transfer element 2.

The modification of the interference diagram on the substrate to be monitored is effected by virtue of the frequency modification of the incident light by a moving object. This frequency modification is generally known as the Doppler effect. The frequency shift is proportional to the speed of the particle, and the interference diagram is consequently modified.

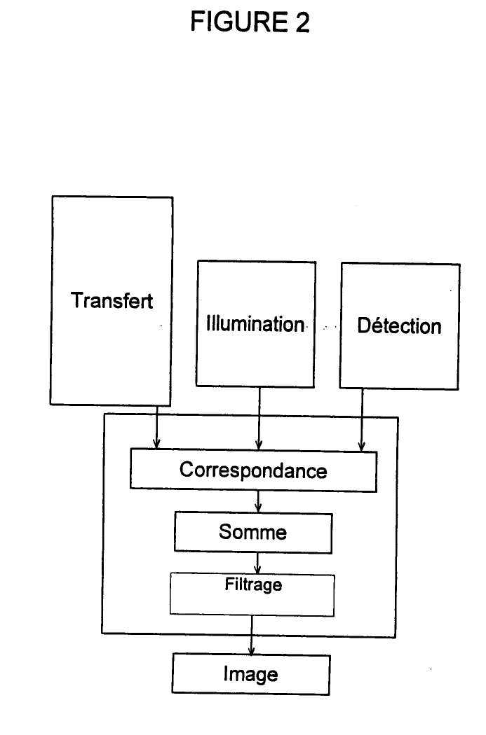

As is shown in FIG. 2, steps of transferring the semi-conductor wafer 1, of illumination by the source 4 and detection by the detection unit 6 can be simultaneous. More particularly, illumination may take place during at least part of the transfer. Detection may take place during at least part of the illumination. A light source 4 and a detection unit 6 may be provided which are stationary. The fields of illumination and detection may correspond. The field of illumination may be wider than the field of detection.

After completion of the sum, an optional filtering step can be carried out e.g. by thresholding. Thresholding may be seen as subtraction by a value independent of the coordinates of the pixel. As output, one obtains an image of defects on the surface of the semi-conductor wafer 1, conveniently showing up local defects such as dust, holes or crystalline defects, and elongate defects such as grooves.

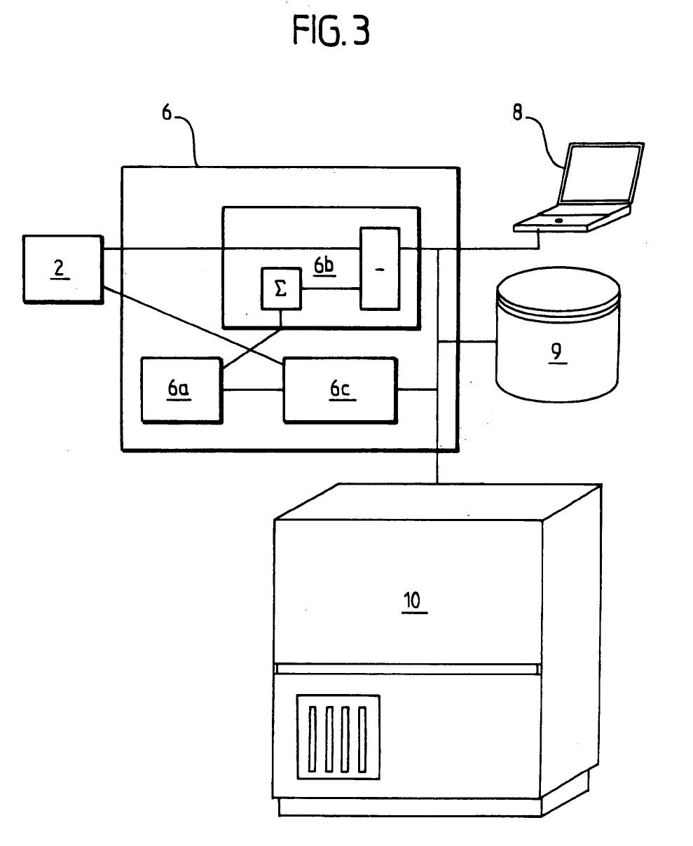

A possible embodiment of the monitoring and inspection device is shown in FIG. 3. The transfer element 2 is connected to the detection unit 6, more particularly to the processing block 6b and to a monitoring block 6c. The connection to the processing block 6b makes it possible to supply the speed v of displacement of the semi-conductor wafer 1 to the processing block 6b. The connection to the monitoring block 6c makes it possible to indicate the presence of a semi-conductor wafer. The monitoring block 6c in particular has the purpose of controlling the reading of optical data by the sensor 6a. The sensor 6a is connected to the processing block 6b in order to supply image data thereto and to the monitoring block 6c. The monitoring block 6c controls the detection of light intensity by the sensor 6a, in particular according to the position of the wafer 1 during displacement by the transfer element 2. The monitoring block 6c may thus receive position data from the transfer element 2.

The output of the detection unit 6 may be connected to a man/machine interface 8, e.g. of the type including a screen and/or a keyboard. The screen may permit display of the defect images supplied by the processing block 6b. The detection unit 6 may also be connected to a data store 9, e.g. in the form of a storage disk, a USB key etc. The detection unit 6 may be connected at the output to a machine 10 for manufacturing semi-conductor devices, e.g. a furnace, a depositing machine or a polishing machine, etching apparatus, or lithography apparatus. The detection unit 6 supplies to the manufacturing machine 10 data relating to the defects of the semi-conductor wafer 1 and position data of the semi-conductor wafer 1 or else identification data.

Furthermore, as the semi-conductor wafer 1 is capable of being equipped with markers, e.g. markers for optical detection, the processing block 6b can be configured to identify the said markers, e.g. for the purpose of orientation of the semi-conductor wafer 1.

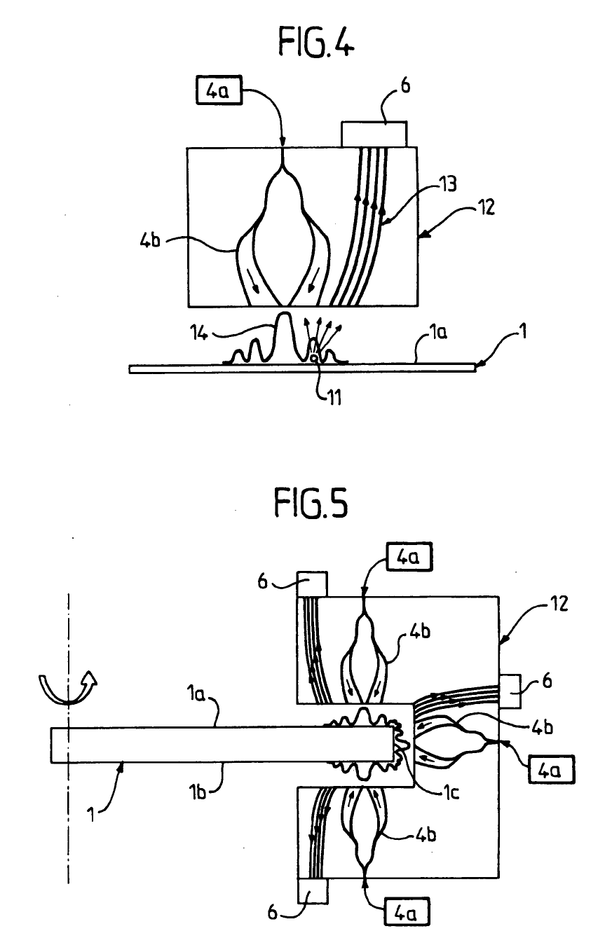

As is shown in FIG. 4, an interferometric block 12 or head is disposed between the light generator 4a and the semi-conductor wafer 1. The light conductor 4b is incorporated in the interferometric block 12. The light conductor 4b may include a Mach-Sender interferometer. The interferometric block 12 includes a wave guide 13 disposed between the detection unit 6 and the semi-conductor wafer 1. The wave guide 13 may be of the multi-mode type. The wave guide 13 may include an input for the reflected beam and optical fibers between the input and the detection unit 6. The interferogram 14 is a result of the interference between the incident beams, unlike in the above-mentioned FR 2 757 953, according to which a single incident beam is applied with comparison of the reflected beam and of the incident beam. The interferogram 14 or interference diagram is tangent to the surface 1a but has been shown raised for the purposes of explanation.

The detection unit 6 may include an optical sensor, e.g. an array of detectors including 1, 2, 4, 8 or 16 channels. In this case, the optical data are representative of the surface 1a whilst being different from an image.

As is shown in FIG. 5, a semi-conductor wafer 1 is inspected by a plurality of inspection and monitoring devices. An upper surface 1a, a lower surface 1b and an edge surface 1c can be inspected substantially simultaneously. An inspection and monitoring device can be oriented towards the said surfaces. The interferometric block 12 can be shared by the three devices. The interferometric block 12 may include three light conductors 4b and three wave guides 13, although the number 3 is not limiting. The inteferometric block 12 may be associated with three light e.g. laser generators 4a, and with three detection units 6, in particular optical sensors. Furthermore, the wafer 1 is in this case set in rotary motion.

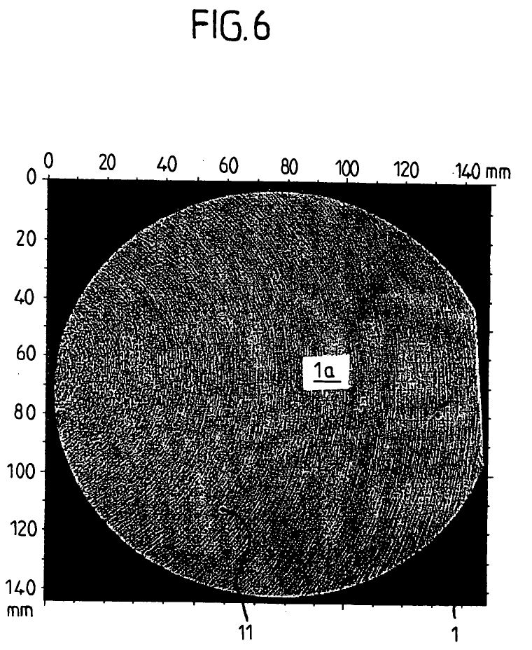

In FIG. 6, the surface 1a of a real wafer 1 has been reproduced. The surface 1a includes local defects 11.

In one embodiment, the monitoring and inspection device of semi-conductor wafers in movement includes a lighting source for a semi-conductor wafer supported on a transfer element. The lighting source is of the type with two incident beams directed on to a surface of the wafer. The incident beams are inclined relative to the normal to the said surface. The device also includes a device for detecting fringes of interference in the beam reflected by the wafer surface. Since the speed of displacement of the wafer, the wavelength of the light beam and the interval between the fringes of interference are known, the locality of the defects can be deduced. The device is well-suited to the location of defects of several microns in width and/or length.

The processing block may include a point-by-point comparison function of a variable representing defects in the surface 1a with another variable. This function may include a subtractor.

The device may include a connection between the transfer element and the detection unit in order to transmit coordinates of the wafer to the detection unit. The detection unit may include an assembly for taking optical data provided with detection elements and a processing block connected to the assembly for taking optical data.

The processing block may be provided with a means of calculating a correspondence between coordinates of a zone located on the surface of the wafer and an optical data element, during transfer of the wafer, and generate a representation of the surface of the wafer by processing a plurality of data acquired successively by the assembly for taking optical data.

The detection unit may include an assembly for taking optical data provided with detection elements and a processing block connected to the assembly for taking optical data and to the said connection, the processing unit being provided with means of calculating a correspondence between coordinates of one zone located on the surface of the wafer and an optical data element, during the conveying of the wafer, and may generate a representation of the surface of the wafer by processing a plurality of optical data taken successively by the assembly for taking optical data.

The detection unit may be triggered upon displacement of the wafer by the transfer element.

The processing unit may include an adder of optical data corresponding to one and the same zone located on the surface of the wafer. The sensitivity of the device is increased.

The processing block may include means of detecting at least one marker on the wafer. The marker may be represented on the images.

The detection unit may include a sensor with integrated optics on a semi-conductor or glass substrate. The optics may include a glass in which the wave guides may be formed by ion exchange on glass.

The light source may be coherent. The incident light beams may be stationary.

The light source may include a source with light emitting diodes, in particular laser.

The distance between the system and the surface to be inspected may be between 50 microns and 5 millimeters.

The transfer element may include gripper arms for grasping the wafer. The transfer element may include holding means operating by suction or by grasping of the wafer. A monitoring device may be disposed upstream and/or downstream of a chamber for measuring or manufacturing.

In one embodiment, the light source includes at least one pair of transmitting optical guides. The transmitting optical guides may be connected by an optical fiber to a light source.

The transmitting optical guides may be contrived to supply two coherent optical beams. The optical guides may be realized by ion exchange on a glass substrate. The ends of the optical guides may be inclined relative to one another so that the incident beams converge with one another at a determined surface corresponding to the surface of the semi-conductor wafer 1.

The detection unit may be triggered upon displacement of the wafer by the transfer element.

A system of manufacturing semi-conductor wafers may include at least one measuring chamber and at least one device above.

The system of manufacturing semi-conductor wafers may include at least one measuring chamber and at least one monitoring and inspection device, e.g. mounted upstream or downstream.

The present description, having a specific character, may if necessary serve to define the invention.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. Device for inspecting semi-conductor wafers in motion, the device comprising a light source for at least one wafer supported by a transfer element, the light source being configured to transmit two incident beams on to a surface of the wafer, the incident beams forming between them a predetermined angle in order to form an interference zone and being inclined relative to the normal to the said surface, and a unit for detecting the light diffused by the surface of the wafer in order to detect interference fringes in the beam reflected by the surface of the wafer, the detection unit being configured to supply electronic signals representing defects on the surface of the wafer.

2. Device according to claim 1, comprising a connection between the transfer element and the detection unit in order to transmit the coordinates of the wafer to the detection unit.

3. Device according to claim 2, wherein the detection unit comprises an assembly for taking optical data provided with detection elements, and a processing block connected to the assembly for taking optical data and to the said connection, the processing unit being provided with means of calculating a correspondence between coordinates of a zone located on the surface of the wafer and an optical data element during transfer of the wafer, and generating a representation of the surface of the wafer by processing a plurality of optical data taken successively by the assembly for taking optical data.

4. Device according to claim 3, wherein the processing block comprises an optical data adder corresponding to one and the same zone located on the surface of the wafer.

5. Device according to claim 3, wherein the processing block comprises means of detecting at least one marker on the wafer, the marker being represented in the images.

6. Device according to claim 1, wherein the detection unit comprises an integral optical sensor, in particular operating by ion exchange on glass.

7. Device according to claim 1, wherein the light source comprises a laser and/or an element with light-emitting diodes.

8. Device according to claim 7, wherein the light source comprises at least one laser diode.

9. Device according to claim 1, wherein the distance between the output of the wave guides and the surface to be inspected is between 50 microns and 5 millimeters.

10. Device according to claim 1, wherein the transfer element comprises systems of holding the wafer by grasping or suction.

11. Device according to claim 1, wherein the light source and/or the wave guide is disposed upstream or downstream of a chamber for measuring or carrying out a step in the manufacture of integrated circuits.

12. Device according to claim 1, wherein the system of inspection is disposed upstream or downstream of a chamber or tool intended to carry out a step in the manufacture of semi-conductor substrates.

13. Device according to claim 1, wherein the detection unit is triggered upon displacement of the wafer by the transfer element.

14. Device for inspecting wafers in motion, the device comprising a light source for lightning at least one wafer supported by a transfer element, the light source being configured to transmit two incident beams on to a surface of the wafer, the incident beams forming between them a predetermined angle in order to form an interference zone and being inclined relative to the normal to the said surface, a sensor for sensing the light diffused by the surface of the wafer in order to detect interference fringes in the beam reflected by the surface of the wafer, and a processing unit receiving an output of the sensor and configured to supply electronic signals representing defects on the surface of the wafer.

15. System of manufacturing semi-conductor wafers, comprising at least one measuring chamber and at least one device according to claim 1.

16. System of manufacturing semi-conductor wafers, comprising at least one measuring chamber and at least one device according to claim 14.
